(19) United States
(12) Patent Application Publication
(10) Pub. No.: US 2012/0158528 A1
(43) Pub. Date: Jun. 21, 2012

(54) EFFICIENT TRANSACTIONS AT A POINT OF SALE LOCATION

(75) Inventors: Wesley Hsu, Fremont, CA (US); Russell Bauder, San Jose, CA (US)

(73) Assignee: eBay, Inc., San Jose, CA (US)

(21) Appl. No.: 12/974,278

(22) Filed: Dec. 21, 2010

(51) Int. Cl. G06Q 20/00; G06Q 30/00

(52) U.S. Cl. 705/16; 235/375

(57) ABSTRACT

Systems and methods are provided for efficient transactions according to one or more embodiments. According to an embodiment, a method for efficient transactions comprises associating an identifier to a seller, wherein the identifier is adapted to in turn be provided to a user in connection with one or more transactions at a point of sale (POS) location, and wherein the identifier is mapped to particular identification information of the seller at a remote location. The method also comprises receiving, at the remote location, input from a user device upon the user selecting the user device in connection with the one or more transactions, wherein the input includes the identifier and is made at the POS location. Furthermore, the method comprises facilitating the one or more transactions based on the received input including the identifier that is mapped to the particular identification of the seller. In one or more embodiments, the method further comprises providing information to the seller confirming the facilitating of the one or more transactions.

### BACKGROUND

1. Technical Field

Embodiments of the present disclosure generally relate to transactions, and more particularly, to methods and systems for efficient transactions at a point of sale location.

2. Related Art

Financial transactions such as in-person purchases at a point of sale (POS) location generally involve a form of payment selected by a customer including cash, a check, or a transaction card such as a credit card, a debit card or a gift card. These forms of payment are widely used in all aspects of in-person commerce. However, such forms of payment may be inefficient and introduce delays.

For example, in certain POS locations such as a restaurant or a retail store, paying with a credit card may delay the completion of a transaction as a result of a merchant not being able to rapidly run the credit card in the restaurant or retail location. For instance, in a crowded restaurant, when a customer is ready to leave, the customer generally may have to wave down or wait for a busy server to provide a credit card for payment, wait for the credit card to be processed, wait for a receipt, etc. These delays may lead to customer frustration due to having to wait when the customer is ready to leave. In addition, these delays may lead to decreased business for the restaurant due to inefficiency in turnover of tables, which is crucial to profitability.

Although customers may select to pay with cash, check, or a transaction card, a need exists for improved methods and systems for more efficient transactions at a POS location.

### SUMMARY

As will be further described herein in relation to one or more embodiments, methods and systems are provided for efficient transactions such as financial transactions at a point of sale (POS) location. Customers at the POS location may use their user devices (e.g., their mobile devices) to pay for goods and/or services based on information provided by a seller, for example, on a sticker, a bill, a check or the like. Instead of being limited to paying with conventional forms of payment including cash, a check, or a transaction card such as a credit card, a debit card, a gift card, etc., paying with a user device increases the speed and efficiency of a transaction.

Once payment is made via a user device, a payment confirmation may be provided to the POS location such that the payment confirmation may be displayed on a seller's computing device such as on a touch screen or a mobile device at the POS location. As such, a person at the POS location may manage all incoming payments via the computing device at the POS location.

In accordance with an embodiment of the disclosure, a method for providing efficient transactions comprises providing an identifier to a seller, wherein the identifier is adapted to in turn be provided to a user in connection with one or more transactions at a point of sale (POS) location, and wherein the identifier is mapped to particular identification information of the seller at a remote location. The method also comprises receiving, at the remote location, input from a user device upon the user selecting the user device in connection with the one or more transactions, wherein the input includes the identifier. Furthermore, the method comprises facilitating the one or more transactions based on the received input including the identifier that is mapped to the particular identification of the seller.

In accordance with another embodiment of the disclosure, a user device comprises an input interface. The user device also comprises one or more processors and one or more memories adapted to store a plurality of machine-readable instructions which when executed by the one or more processors are adapted to cause the user device to: receive inputs in connection with a transaction via the input interface, wherein the inputs include an identifier provided by a seller at a POS location in connection with one or more transactions; and transmit the inputs to a remote location for completing the one or more transactions.

In accordance with another embodiment of the disclosure, an efficient transaction system comprises a user device in communication with a remote location via a network. The system also comprises one or more processors and one or more memories adapted to store a plurality of machine-readable instructions. When executed by the one or more processors, the machine-readable instructions are adapted to cause the efficient transaction system to receive, at the remote location, input information from the user device upon the user selecting the user device in connection with the one or more transactions, wherein the input information includes the identifier; and facilitate the one or more transactions based on the received input information including the identifier that is mapped to the particular identification of the seller.

In accordance with another embodiment of the disclosure a method for efficient transactions comprises selecting an identifier that is mapped to particular identification information maintained at a remote location; offering the identifier to a user in connection with a transaction at a POS location, wherein if the user accepts the offering, the user inputs and transmits transaction information including the identifier to the remote location; and receiving confirmation information on whether the transaction was facilitated by the remote location.

These and other features and advantages of the embodiments of the present disclosure will be more readily apparent from the detailed description of the embodiments set forth below taken in conjunction with the accompanying drawings.

### BRIEF DESCRIPTION OF THE FIGURES

FIG. 1 is a block diagram illustrating a system for conducting efficient transactions according to an embodiment of the present disclosure.

FIG. 2 is a flowchart for an efficient transaction according to an embodiment of the present disclosure.

FIG. 3a is an example of an identifier that may be used in connection with a transaction according to an embodiment of the present disclosure.

FIG. 3b is an example of an identifier provided to a customer according to an embodiment of the present disclosure.

FIG. 3c is an example of an identifier displayed directly on an item that may be used in connection with a transaction according to an embodiment of the present disclosure.

FIG. 3d is an example of an identifier included in a readable code that may be used in connection with a transaction according to an embodiment of the present disclosure.

FIG. 4 is an example of a user device used in connection with a transaction according to an embodiment of the present disclosure.

FIG. 5 is an example of a user device showing a symbol in connection with a transaction according to an embodiment of the present disclosure.

FIG. 6a illustrates a user device at a POS location according to an embodiment of the present disclosure.

FIG. 6b illustrates a computer device at a POS location according to an embodiment of the present disclosure.

FIG. 7 is a screen showing a custom application according to an embodiment of the present disclosure.

Like element numbers in different figures represent the same or similar elements.

### DETAILED DESCRIPTION

In accordance with one or more embodiments described herein, methods and systems are provided for efficient transactions such as financial transactions at a point of sale (POS) location. For instance, customers may select to pay for goods and/or services with a user device such as a mobile device instead of being limited to paying with cash, check, or a transaction card such as a credit card, a debit card, a gift card, etc. Selecting a user device as a form of payment at the POS location may improve the speed of transactions, allowing customers to quickly pay for goods and/or services as well as helping merchants or service providers (hereinafter, generally referred to as “sellers”) to increase business and profitability.

Initially, a remote location, for example, a payment service provider may provide a seller with an identifier. The identifier may be mapped to the particular seller's identification information maintained at the remote location. The identifier may include, for example, a “pay name” or any appropriate icon, word, symbol, label, phrase, name or other identifier chosen by the seller. In addition to an identifier such as a pay name, one or more additional unique identifiers may be used in connection with a transaction at a POS location. For example, a code or string containing the “pay name” plus an additional unique identifier such as an order number may be included. Such additional unique identifiers, e.g., an order number, may be linked to a seller's POS computing device or system. The identifier, plus any additional unique identifiers appended therewith, may be displayed on a sticker, a card, a tag, a label, a magnet, a decal, etc., or may be directly displayed or printed as part of a bill, a check, a price tag, or the like (hereinafter generally referred to as “sticker”).

In financial transactions at a POS location, the seller may offer the sticker, which includes the seller's identifier plus any additional unique identifiers, in connection with an alternate way for a customer to pay. In this regard, the seller may provide the sticker bearing the seller's “pay name” and for example, an order number, to the customer when the customer desires to pay for goods and/or services at the point of sale (POS) location. The order number or other information specific to the transaction may be provided separately from the sticker.

The customer may select to use his or her user device in connection with the transaction (e.g., instead of paying with cash or a transaction card). To that effect, the customer may simply input transaction information including the identifier as it appears on the sticker into his or her user device and transmit the transaction information to a remote location. Once the transaction information including the identifier, e.g., the pay name, is received at the remote location, the identifier is mapped to the seller's identification information maintained at the remote location, and the remote location facilitates the financial transaction.

In one or more embodiments, the seller may offer the customer a sticker having a user device-readable code such as a QR code displayed or printed thereon. The readable code would map to the seller's identifier at the remote location and include any additional unique identifiers linked to the seller's POS system.

Once payment is made, the remote location may send information back to the seller confirming payment at the POS location. The payment confirmation may be displayed on a computing device such as on a touch screen at the POS location. As such, a person at the POS location may manage all incoming payments via the computing device at the POS location.

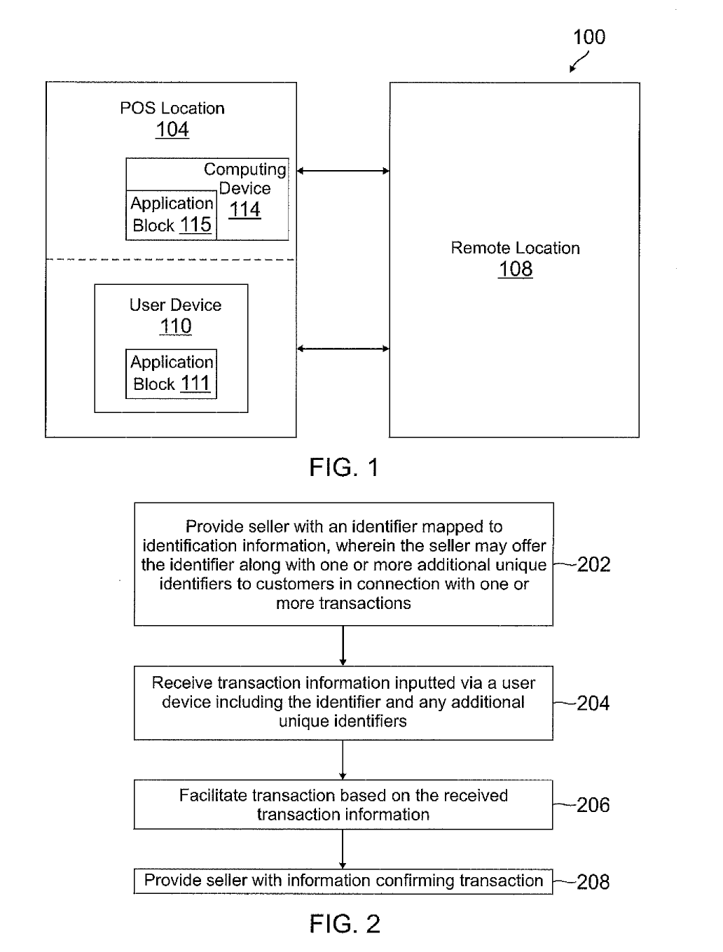

Referring now to the drawings wherein the showings are for purposes of illustrating embodiments of the present disclosure only, and not for purposes of limiting the same, FIG. 1 is a block diagram illustrating a system for conducting efficient transactions according to an embodiment of the present disclosure.

In system 100, a remote location 108 is in communication with a POS location 104 having a computing device 114 and a user having a user device 110. Remote location 108 may include a payment service provider such as PayPal, Inc. or eBay, Inc. of San Jose, Calif., or one or more financial institutions, or a respective intermediary that may facilitate transaction routings between users at multiple POS locations and, for example, financial institutions. Remote location 108 may include a server and maintain data or information related to, for example, account information, passwords, PINs, passcodes, seller or terminal identifiers, and/or user device information such as user device identifiers. For example, an identifier associated with a seller may be associated with an account number or a name or a POS location identifier. A password may also be associated with a unique account or with a unique user device (having multiple accounts). Data or information may be stored according to various schemes for coordinating accounts, passwords, PINs or passcodes, user devices and seller information.

POS location 104 may be any physical location for conducting business (profit or non-profit) by a seller such as a merchant or service provider including, for example, a restaurant, a retail store, a service facility such as a gym, a spa, an office, or any other type of business that provides goods and/or services. Alternatively, a user may self operate at the POS location 104, for example, at vending machines, ATMs, laundromats, ticket dispensers, etc.

Computing device 114 at POS location 104 may be implemented using any appropriate combination of hardware and/or software configured for wired and/or wireless communication over a network. For example, computing device 114 may be implemented as a personal computer, a notebook computer, a personal digital assistant (PDA), a smart phone, and/or other types of computing devices, which may be in communication with the Internet or another network. Also, computer device 114 may include a touch screen display according to one or more embodiments.

Computing device 114 may include an Application component or block 115 (Application block) where applications may be loaded. One application that may be loaded in Application block 115 is a payment application provided by remote location 108 to facilitate financial transactions. Computing device 114 may have a digital signature particular to computing device 114, to POS location 104 or to a particular seller. Application block 115 may also include an application provided by remote location 108 for managing payments at a POS location including receiving transaction information and/or confirmation and displaying such information and/or confirmation on computing device 114 as will be described in more detail below. In addition, computing device 114 may include various applications as may be desired in particular embodiments to provide desired features to computing device 114.

User device 110 may be implemented using any appropriate combination of hardware and/or software configured for wired and/or wireless communication over a network. For example, user device 110 may be implemented as a wireless device, e.g., a wireless telephone, a personal digital assistant (PDA), a smart phone, a key fob, a smart card, a notebook computer and/or other types of mobile computing devices, which may be in communication with the Internet or another network.

User device 110 may include an Application component or block 111 (Application block) where applications may be loaded. One application that may be loaded in the Application block is a mobile payment application wherein user device 110 is adapted to be used as a mobile wallet. In one or more embodiments, user device 110 may have a digital signature particular to user device 110. Application block 111 may also include other pre-loaded applications, for example, a payment service provider application to facilitate financial transactions. In addition, user device 110 may include various applications as may be desired in particular embodiments to provide desired features to user device 110.

User device 110, remote location 108, for example a payment service provider, as well as computing device 114 located at POS location 104 may each include one or more processors, memories, and other appropriate components for executing instructions such as program code and/or data stored on one or more computer readable mediums to implement the various applications, data, and methods described herein. For example, such instructions may be stored in one or more computer readable mediums such as memories or data storage devices internal and/or external to various components of the system, and/or accessible over a network, which may be implemented as a single network or a combination of multiple networks. For example, in various embodiments, a network may include the Internet or one or more intranets, landline networks, wireless networks, and/or other appropriate types of networks.

Referring now to FIG. 2, a flowchart for an efficient transaction is illustrated according to an embodiment of the present disclosure. FIG. 2 may be implemented by the system of FIG. 1 according to one or more embodiments.

In block 202, remote location 108 may provide a seller with an identifier, which is mapped to the particular seller's identification information maintained at remote location 108. Note that in other embodiments, the seller may select the identifier, as long as the remote location is able to associate the identifier with the seller. The seller, in turn, may provide or offer the identifier to a customer in connection with one or more transactions at a POS location. The seller's identification information may be stored at remote location 108, for example, for facilitating, confirming or verifying one or more transactions. The seller may select an appropriate identifier that is simple and clear for customers to use and that may be correspondingly mapped to the seller's identification information. In this regard, according to one or more embodiments, a seller may register with remote location 108 and may request a password and/or other features for conducting transactions. The seller may choose a seller identifier, for example, by entering information online, by filling out a hardcopy form, etc. Remote location 108 may then provide the requested identifier, for example online or by mail, in the form of a sticker as will be described in more detail below according to one or more embodiments. In one embodiment, the seller may access a sticker-creating page that may be printed in view of one or more transactions at the POS location.

A seller may select an identifier such as an icon, word, symbol, label, phrase or name such as the seller's name (“pay name”). The seller's selected identifier such as a “pay name” may be displayed on a “sticker,” which may be, for example, a tag, a card, a label, a magnet, a decal, etc., and which may be placed on an item, for example, on a tray at the POS location. A “sticker” may also include content or images displayed or printed directly thereon, or may be part of a bill, a price tag, a check or the like.

In addition to an identifier such as a “pay name,” which is mapped to the seller's identification information at the remote location, a sticker may also include one or more additional unique identifiers of the seller or POS location such as an order number, a part number, an item number, a table number, etc., as well as any other pertinent transaction information. That is, the sticker may include a code or string that contains some or all of the following information: a seller identifier such as a pay name, a price, one or more additional unique identifiers (e.g., an order number), etc.

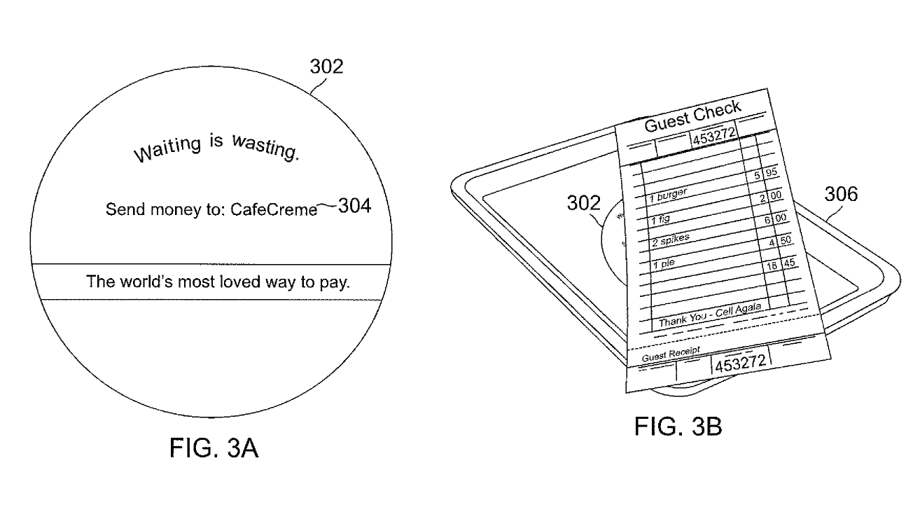

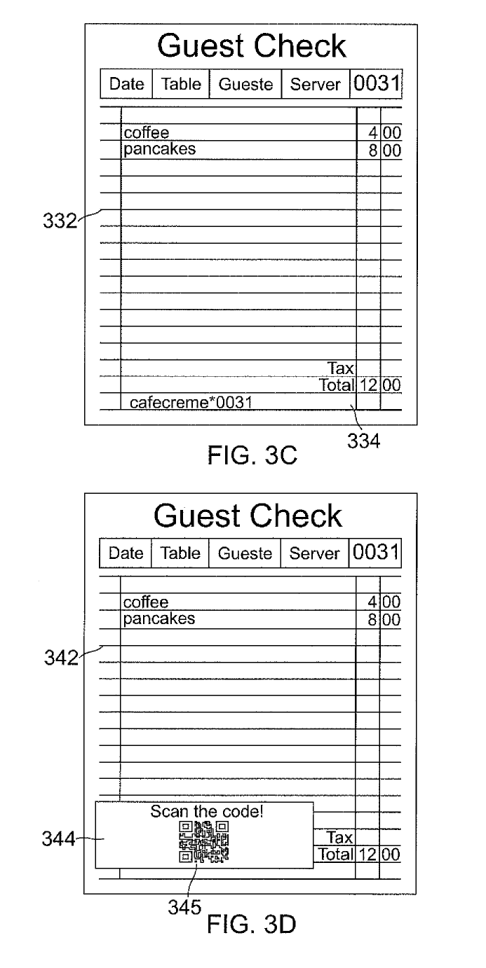

An example of an identifier according to an embodiment of the present disclosure is illustrated in FIG. 3a. An identifier may be included on a sticker, which may be offered to a customer at POS location 104 as an option for payment as will be described below with respect to the embodiment of FIG. 3b. FIG. 3c illustrates another embodiment of an identifier that is displayed or printed directly on an item such as a bill, a check or the like. FIG. 3d illustrates yet another embodiment of an identifier where the identifier is included in a readable or scannable code such as a QR code, and which may be displayed or printed directly on an item.

Referring back to FIG. 2, in block 204, if a user selects user device 110 in connection with a transaction such as a form of payment, remote location 108 may receive transaction information via the user's inputs on user device 110 including the seller's identifier such as a “pay name” displayed on the sticker, which is mapped to the seller identification information, along with any additional unique identifiers such an order number. It should be understood that in one or more embodiments, in addition to the seller's identifier (mapped to the seller's identification information at remote location 108) and the additional unique identifier(s), transaction information may include a date, a time, a payment amount, a terminal identifier, etc., which may be transmitted to remote location 108 by user device 110. Remote location 108 may store some or all of the received transaction information and authenticate a password, a digital signature, or other authentication information associated with user device 110.

It should be noted that inputs via user device 110 may be done via appropriate interfaces of user device 110 such as via a keypad, a keyboard, a touch screen, voice recognition, a scanner or a reader (e.g., a QR code reader), and/or the like.

In block 206, upon receiving the transaction information and mapping the identifier such as a “pay name” to the seller's identification information, remote location 108 may facilitate payment to the seller at POS location 104. The transaction may be confirmed or rejected depending on whether the received transaction information as well as authentication information, for example, a password, matches pre-determined information maintained at remote location 108. In one embodiment, a user identifier may be used by remote location 108 to associate user device 110 (or correspondingly a customer) with a particular account maintained by remote location 108. Once confirmed, remote location 108 may notify, for example, send a message to user device 110 indicating that the transaction has been confirmed. Conversely, if the transaction is rejected, remote location 108 may reply that the transaction was denied.

In block 208, information may be provided to the seller confirming the transaction at POS location 104 as will described in more detail below, for example, with respect to the embodiments of FIGS. 5-7.

It should be appreciated that sellers may offer a seller's identifier to customers in connection with one or more transactions in different ways. Sellers may choose a unique seller's name as an identifier that maps to their identification information maintained at the remote location. According to one or more embodiments, a seller may provide the identifier to a customer as will be described below with respect to the embodiments of FIGS. 3a and 3b. In other embodiments, the seller may provide the identifier along with an additional unique identifier linked to the seller's POS system to a customer as will be described below with respect to the embodiments of FIGS. 3c and 3d. Upon receiving the identifier information along with any additional unique identifiers from the seller, the customer may input transaction information including the seller's identifiers into his or her user device in connection with a transaction including, for example, sending payment for goods and/or services.

Referring now to FIG. 3a, an example of an identifier that may be used in connection with a transaction is illustrated according to an embodiment of the present disclosure.

As described above, a remote location such as a service provider may provide a seller with an identifier, which is mapped to the seller's identification information as maintained at the remote location. The seller may offer the identifier to customers in connection with one or more transactions at a POS location, for example, as an option to pay for goods and/or services at the POS location.

The seller may choose an identifier that is simple and clear for customers to use. The seller's identifier may be, for example, an icon, word, symbol, label, phrase, name or any other appropriate identifier that is to be used for payment, i.e., a “pay name”. In the example of FIG. 3a, a sticker 302 includes an identifier 304 in the form of a “pay name” that reads: “Café Crème”. Identifier 304 or pay name “CafeCreme” may be mapped to identification information of that particular seller CafeCreme at remote location 108.

It should be appreciated that sticker 302 may be of any form, shape, color or material (i.e., paper, plastic, clear, opaque, magnetic, etc.) and may include any appendages, adhesives, fastening means, etc. or any content, lettering, drawings, pictures, digital displays, or magnetic stripes thereon as may be appropriately selected by a seller or by remote location 108.

FIG. 3b is an example of an identifier provided to a customer according to an embodiment of the present disclosure. The seller may provide sticker 302 described above with respect to the embodiment of FIG. 3a to a customer in connection with the payment for goods and/or services at POS location 104. For example, in a POS location such as a restaurant, sticker 302 may be placed on an item such as a bill or customer check, a table, a tip tray, etc. as indicated by reference number 306.

Referring now to FIG. 3c, an example of an identifier displayed directly on an item that may be used in connection with a transaction is illustrated according to an embodiment of the present disclosure.

As described above with respect to the embodiments of FIGS. 3a and 3b, a seller may provide an identifier to a customer on a sticker that may be an actual decal, tag, label, etc. that may be placed on an item to be offered to a customer in connection with a transaction at a POS location. In the embodiment of FIG. 3c, the seller may provide the identifier to a customer in the form of content 334 printed directly on a guest check 332, which may also be a bill, a price tag, or the like. That is, content 334 may be part of the printout of guest check 332. Content 334 may be in any form and may include, for example, an image. In addition to a seller's identifier or “pay name”, which maps to the seller's identification information at a remote location, content 334 may also include additional unique identifier(s) of the seller such as an order number, a part number, a table number, etc., which would work with the seller's POS system or computing device. As such, according to one or more embodiments, content 334 may include the seller's identifier, any additional unique identifiers such as an order number, a price, and/or any and all other information related to a transaction.

In the example of FIG. 3c, content 334 includes a pay name “CafeCreme” appended to, for example, an order number “0031” such that it reads “cafecreme*0031”.

Referring now to FIG. 3d, an example of an identifier included in a readable code that may be used in connection with a transaction is illustrated according to an embodiment of the present disclosure. A seller may provide an identifier to a customer in the form of content 344 printed directly on a guest check 342, which may also be a bill, a price tag, or the like. That is, content 344 may be part of the printout of guest check 342. Content 344 may be in any form and may include, for example, an image. In this embodiment, content 344 includes a QR code 345. A seller's identifier or “pay name”, any additional unique identifier(s) of the seller such as an order number, a part number, a table number, etc. as well as any other information related to a transaction may be embedded in QR code 345. It should be appreciated that any feasible code that may be read or scanned by a user device can be used according to one or more embodiments. It should also be noted that in other embodiments, an appropriate code such as a QR code may also be part of sticker 302 described above with respect to FIGS. 3a and 3b.

A user device may include an input or be adapted to read or scan QR code 345 thus giving a user the option to carry out a transaction such as paying for goods and/or services by simply scanning QR code 345 and sending payment to a remote location.

It should be appreciated that sellers may provide customers with appropriate identifiers mapped to seller's identification information in many different ways other than on a sticker or on a bill, customer check, table, tip tray or the like. For example, a seller may provide the identifier to a customer verbally, or as part of a larger display such as a menu, a bulletin board, or an electronic display, which may be found at POS location 104. In other embodiments, sellers may provide the identifier to customers on a self-operated machine thereon such as on a vending machine, an ATM machine, a laundromat machine, etc. For example, a sticker may be conspicuously placed or fastened to the self-operated machine. In further embodiments, for example, in the context of a warehouse, a retail store or other POS location that offers inventory for sale, a sticker may be placed on actual sale items or products so that customers may, if they wish, walk up to the item or product and input the identifier and/or any other appropriate transaction information on a user device in connection with a transaction, for example, to pay for the item or product.

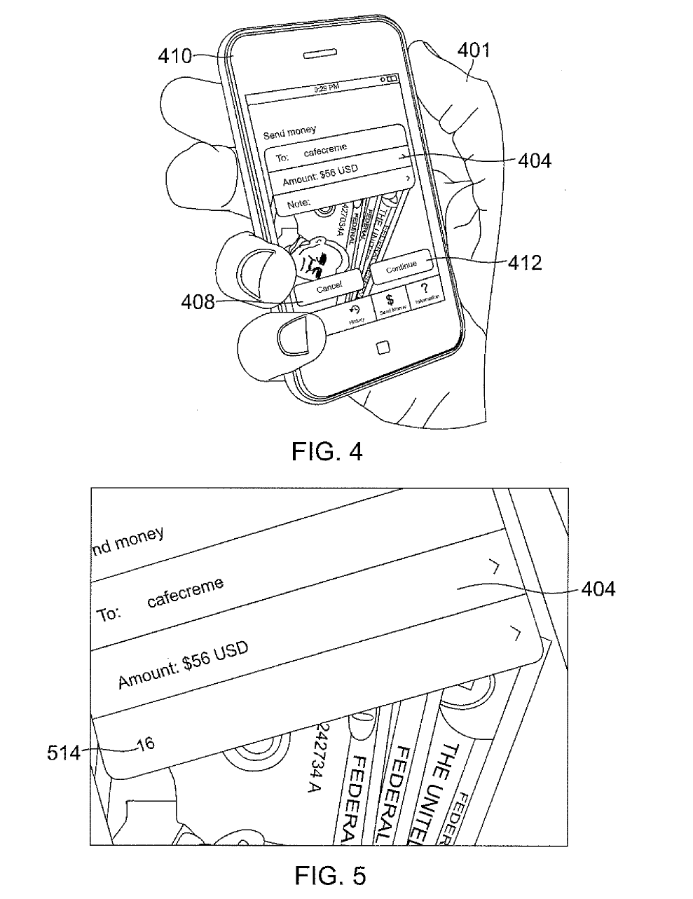

Referring now to FIG. 4, an example of a user device used in connection with a transaction is illustrated according to an embodiment of the present disclosure. It should be appreciated that user device 110 of FIG. 1 may be implemented by the user device illustrated in the embodiment of FIG. 4 according to one embodiment.

Upon being offered an identifier, for example on a sticker 302 or as part of a guest check 332 or 342 as described above, in connection with a transaction at a POS location, a customer 401 may select to pay for goods and/or services at POS location 104 by using a user device 410 instead of cash, a check, a transaction card or other form of payment.

In one or more embodiments, customer 401 may manually enter or input the seller's identifier information found on sticker 302 or guest check 332 along with any other appropriate transaction information such as the total amount owed, notes, etc. For example, in the embodiment of FIG. 4, customer 401 may enter the “pay name” of “CafeCreme” as found on sticker 302, the “amount” of $56.00 USD, and may optionally enter a note on screen 404 of user device 410. Once customer 401 enters the appropriate transaction information, customer 401 may review the entered information. At this point, customer 401 may have an option to “Cancel” the transaction by pressing input “Cancel” 408. Alternatively, if customer 401 desires to continue, customer 401 may press input “Continue” 412. Customer 401 may then be prompted to log into a server at remote location 108 to send payment, for example, via a payment service provider application of user device 410.

It should be appreciated that the inputs illustrated in the embodiment of FIG. 4 on screen 404 of user device 410 are adapted to receive data such as transaction information necessary to support a transaction. For example, inputs 404, 408 and 412 as well as other inputs on user device 410 may include a touch screen, a keypad or a keyboard for manually entering transaction information such as a money amount, a password, etc. Inputs may also include a code reader or scanner (e.g., for reading a QR code), a magnetic stripe reader, an RFID chip, Bluetooth, an NFC transponder, an IR communications reader, etc. in order to enter data.

By using user device 410 to pay for goods and/or services at POS location 104, customer 401 may easily input appropriate transaction information and finish the transaction in a matter of seconds.

As such, embodiments of the present disclosure may address customers' issues that may be found in everyday transactions at POS locations such as restaurants or retail stores. For example, in a crowded restaurant setting, it may be difficult for a customer to get the attention of a server once the customer has finished a meal and wants to pay because the server may be busy with other customers. The customer wastes time trying to wave down a server and may become frustrated with an annoying end to a nice meal. The customer is not able to just pay quickly and leave.

Another issue for customers is waiting. For example, in the restaurant setting, if a customer selects to pay with a credit card, the customer provides the credit card to a server. It may be a long while before the credit card is returned to the customer perhaps even making a customer late for a planned event or meeting. Customers waste time waiting for servers to process their credit cards. In the meantime, credit card information may be stolen or just get mixed up with other customers' cards.

Embodiments of the present disclosure may also address sellers' issues that may be found in everyday transactions at POS locations such as restaurants or retail stores. For example, in the crowded restaurant setting, servers may spend valuable time running back and forth with credit cards. This leads to inefficiency and slower table turnover, which in turn translate into fewer customers served and less profitability. It is difficult for sellers to maximize business when servers waste time with credit card transactions and may require more staff to operate the business.

As described above with respect to block 208 of FIG. 2 according to an embodiment, once customer 401 finishes the transaction by using his or her user device 410 (or 110), a seller may want to confirm that payment was indeed made. Remote location 108 may provide information to the seller for confirming payment at POS location 104. In general, this information may allow sellers to manage transactions at the POS location.

Referring now to FIG. 5, an example of a user device showing a symbol in connection with a transaction is illustrated according to an embodiment of the present disclosure.

In an example where POS location 104 is a restaurant or a café, the tables may be identified, for example, by a number, a letter or any other symbol. A server may generally be assigned to work a certain number of tables, for example, a server may be assigned to work tables identified by numbers 15 through 20. When customer 401 selects to make a payment by using user device 410 as described above with respect to the embodiment of FIG. 4, customer 401 may also include the table number or other symbol in the “note” field 514 of screen 404 of user device 410. In the example of FIG. 5, customer 401 inputs table number “16” in note field 514. It should be noted that the seller may provide customer 401 with the appropriate table number or other additional unique identifier such as a customer, order, or table symbol as part of, for example, sticker 302. In other embodiments, customer 401 may be prompted to input the additional unique identifier such as the table number or other customer or table symbol, for example, on a pop-up window or the like. In further embodiments, the appropriate table number or other additional unique identifiers such as a customer, order, or table symbol may be part of an identifier provided to the customer on an item itself such as a bill or check itself (e.g., guest check 332) or may be embedded in a readable code such as a QR code that may be separate or part of an item such as a bill or check (e.g., guest check 342).

As described above with respect to block 206 of FIG. 2 according to an embodiment, remote location 108 may facilitate a transaction, for example, payment to the seller, based on the received inputs from the customer. Along with a payment provided to the seller by remote location 108, the order number, table number or any other appropriate symbol or additional unique identifier (i.e., table number 16 in the café example), may also be passed to the seller as metadata.

The metadata received by a seller from remote location 108 along with payment may be used to confirm that payment was made in connection with a transaction according to various embodiments.

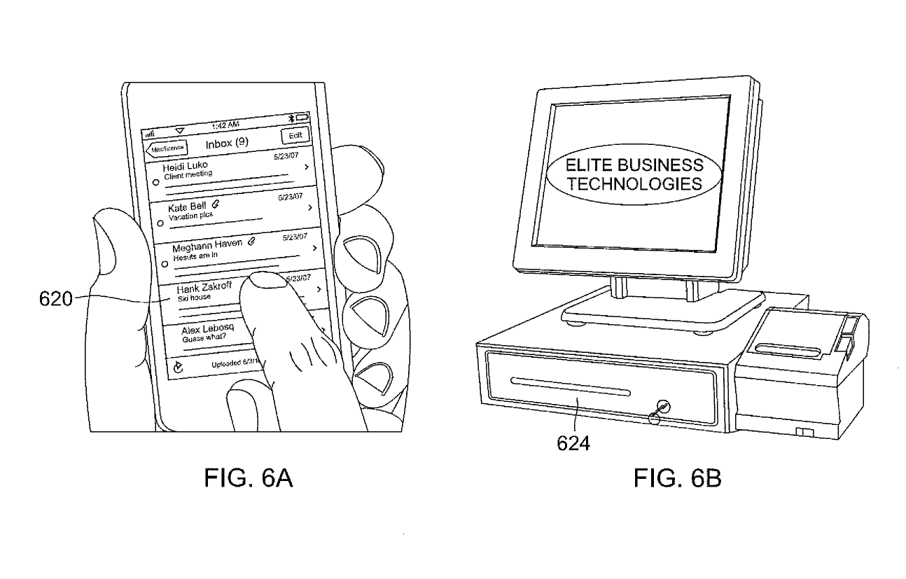

In one embodiment, for example, in a café setting, each server or waitperson may have a user device to which instant payment notification may be sent. FIG. 6a illustrates, according to an embodiment, a user device 620 that may be used by a waitperson or any employee at the POS location to check for notifications and confirm that payments have been made in connection with, for example, a particular customer, an order, or a table in the café setting. In an embodiment, the employee at the POS location may check email via user device 620 to obtain confirmation that payment was indeed made.

FIG. 6b illustrates, according to another embodiment, a computer device 624 at a POS location to which transaction confirmation information may be sent from remote location 108. The transaction confirmation information may include metadata and/or an instant payment notification associated with a transaction. It should be noted that computing device 114 of the embodiment of FIG. 1 may be implemented by computer device 624 according to an embodiment. Computer device 624 may be a terminal, a notebook computer, a PDA, a mobile device, or any other type of computing device located at a designated place in POS location 104, for example, at the front of a café or retail store. An employee may access computer device 624 and review any instant payment notifications to confirm payments and their correlation to customers, order or table number or identifiers.

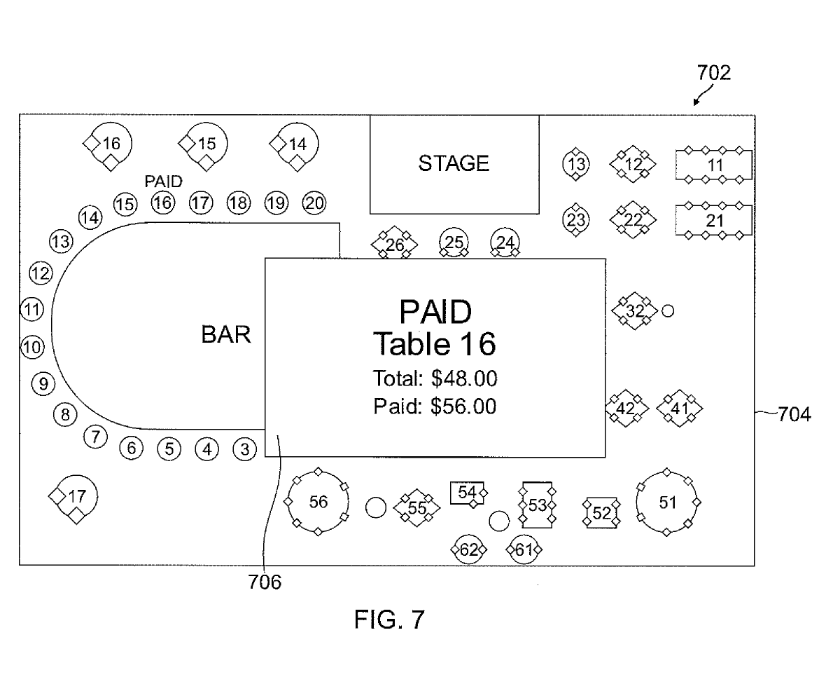

Referring now to FIG. 7, a screen showing a custom application that displays payments is illustrated according to an embodiment of the present disclosure.

According to one or more embodiments, an application 702 may be represented on a screen of computer device 624 managed by an employee at a designated place in POS location 104, or on a user device 6a of an employee at POS location 104. Application 702 may represent a POS location, for example, a café 704 such that payments may be visually displayed therein. It should be understood that POS locations may include other types of merchants or service providers such as restaurants, retail stores, warehouses, etc.

According to an embodiment, application 702 may be implemented by, for example, a Java application wherein the movement of payments may be visually displayed in the context of a POS location such as in café 704. In an embodiment, the application, such as a Java application, may be provided by remote location 108 (e.g., a payment service provider). The application may be adapted for managing payments at the POS location including receiving transaction information and/or confirmation and displaying such information and/or confirmation on computing device 624 (or 114).

Application 702 may display a seating chart of café 704, wherein each table, order, or seat may have a corresponding number, symbol, or other additional unique identifier. According to one or more embodiments, application 702 may allow sellers to create the seating chart for their own particular POS location, or just a simple chart having, for example, order numbers, table numbers or other identifiers. In this embodiment, when a payment is made, a table value passed along with the payment from the remote location triggers a lightbox 706 to pop up. It should be appreciated that in other embodiments, the table value may be highlighted in other ways such as by blinking, or changing colors, for example. Lightbox 706 indicates that table 16 has paid as well as the total amount owed ($48.00) and the amount paid ($56.00). According to one or more embodiments, other information may be included in lightbox 706, for example, a server's name, a tax amount, brief notes, etc.

In other embodiments, further information may be provided and linked to, for example, inventory of a seller such that the seller's inventory is updated upon completion of a transaction. In one specific example, the café may keep track of inventory, for example, a particular sale item or product (e.g., cups, gift items, coffee beans, etc.), which may be linked to corresponding metadata such as an item number. When a particular sale item or product is sold, the remote location may confirm the sale and payment based on the metadata such that upon completion of such a transaction, the seller's inventory is updated to reflect that the particular linked item has been sold. Advantageously, a seller would know if the particular item is out of stock or if inventory is running low.

In an embodiment, one employee may monitor the entire POS location, e.g., café 704, with application 702 via, for example, computing device 624. Also, more than one employee may be able to monitor the POS location, for example, via user device 6a as described above according to an embodiment.

It should be appreciated that although a café setting has been illustrated according to one or more embodiments herein, an application such as application 702 may be configured for and used in other settings, for example, in a warehouse where many inventory items are available such that a user may approach an inventory item having an identifier and use his or her user device to easily pay for a selected item in a fast and convenient manner as described above according to one or more embodiments.

It should be understood that identification information for a particular customer, user device or seller may be set during pre-registration with a remote location. According to one or more embodiments, it is assumed that a customer or a seller has previously registered with the remote location, for example, to open an account. In this regard, it will be appreciated that the customer or seller may have previously provided account information to the remote location, for example, over a network through, for example, a secure connection between user device 110 or computing device 114 at POS location 104 and remote location 108. Alternatively, user device 110 (e.g., user device 410) or computing device 114 (e.g., computer device 624 or user device 6a) at POS location 104 may be personalized during customization by operators, customizers and/or device manufacturers.

As a result of such previous registration, user device 110 or computing device 114 at POS location 104 stores a specific customer or seller identifier, respectively, that may be used to identify the particular customer or seller as having an account maintained by remote location 108. The customer or seller identifier may be implemented, for example, as one or more cookies, operating system registry entries, hardware identifiers, or other types of identifiers.

Transmitted information is compared with predetermined information at the remote location. According to one or more embodiments, the remote location is adapted to authenticate a particular digital signature, account, user, client device, merchant identifier, terminal, POS device identifier, or the like, associated with the transmitted information based on pre-determined or pre-registered information maintained therein.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. It is contemplated that various alternate embodiments and/or modifications to the present disclosure, whether explicitly described or implied herein, are possible in light of the disclosure. For example, although financial transactions have been described according to one or more embodiments, it should be understood that the present disclosure may also apply to transactions where requests for information, requests for access, or requests to perform certain other transactions may be involved.

Having thus described embodiments of the disclosure, persons of ordinary skill in the art will recognize that changes may be made in form and detail without departing from the scope of the disclosure. Thus the disclosure is limited only by the claims.

What is claimed is:

1. A method for efficient transactions comprising:
associating, by a remote location, an identifier to a seller, wherein the identifier is adapted to in turn be provided to a user in connection with one or more transactions at a point of sale (POS) location, and wherein the identifier is mapped to particular identification information of the seller at the remote location;
receiving, at the remote location, input from a user device upon the user selecting the user device in connection with the one or more transactions, wherein the input includes the identifier and is made at the POS location; and
facilitating the one or more transactions based on the received input including the identifier that is mapped to the particular identification of the seller.

2. The method of claim 1, further comprising providing information to the seller confirming the facilitating of the one or more transactions.

3. The method of claim 2, wherein the receiving input further comprises receiving a symbol associated with the one or more transactions at the POS location, and wherein the providing confirming information to the seller further comprises passing the symbol to the seller.

4. The method of claim 2, wherein the providing information to the seller confirming the facilitating of the one or more transactions further comprises sending a notification to one or more employees of the seller on corresponding employee user devices.

5. The method of claim 2, wherein the providing information to the seller confirming the facilitating of the one or more transactions further comprises sending the confirming information to a computer device of the seller, wherein the confirming information is displayed on the computer device.

6. The method of claim 5, wherein a custom application that displays payments is displayed on the computer device.

7. The method of claim 1, wherein the identifier further comprises a label, a phrase, a word and/or a name adapted to be placed on a sticker, and wherein the sticker further comprises paper, plastic, clear and/or opaque materials.

8. The method of claim 7, wherein the sticker further comprises a code adapted to be scanned, lettering, drawings, pictures, digital displays, magnetic stripes, appendages, adhesives and/or fastening means thereon.

9. The method of claim/, wherein the identifier further comprises a label, a phrase a word and/or a name as well as additional unique identifiers of the seller, wherein the identifier is displayed directly on an item.

10. The method of claim 1, wherein the identifier is provided to the user on an item comprising a code adapted to be scanned by an input of the user device.

11. A user device comprising:
an input interface;
one or more processors; and
one or more memories adapted to store a plurality of machine-readable instructions which when executed by the one or more processors are adapted to cause the user device to:
receive inputs in connection with a transaction via the input interface, wherein the inputs include an identifier provided by a seller at a POS location in connection with one or more transactions; and
transmit the inputs to a remote location for completing the one or more transactions.

12. The device of claim 11, wherein the input interface comprises a touch screen, a code reader or scanner, a magnetic stripe reader, an RFID chip, an NFC transponder, Bluetooth, an IR communications reader and/or a keypad for entering the inputs in connection with the transaction.

13. A system for efficient transactions comprising:
a server at a remote location in communication with a server at a point of sale (POS) location and a user device over a network;
one or more processors; and
one or more memories adapted to store a plurality of machine-readable instructions which when executed by the one or more processors are adapted to cause the system to:
associate an identifier to a seller, wherein the identifier is adapted to be offered to a user in connection with one or more transactions at the point of sale (POS) location, and the identifier is mapped to particular identification information of the seller at the remote location;
receive, by the remote location server, input information from the user device upon the user selecting the user device in connection with the one or more transactions, wherein the input information includes the identifier and is entered at the POS location; and
facilitate the one or more transactions based on the received input information including the identifier that is mapped to the particular identification of the seller.

14. The system of claim 13, wherein the plurality of machine-readable instructions are further adapted to cause the system to: provide information to the seller confirming the one or more transactions.

15. The system of claim 14, wherein the plurality of machine-readable instructions are further adapted to cause the system to send the confirming information to a computer device of the seller, wherein the confirming information is displayed on the computer device.

16. The system of claim 13, wherein the remote location further comprises a payment service provider, a financial institution or a respective intermediary adapted to facilitate transaction routings between users at multiple POS locations and the remote location.

17. A method for efficient transactions comprising:
selecting an identifier that is mapped to particular identification information maintained at a server at a remote location;
offering the identifier to a user in connection with a transaction at a POS location, wherein if the user accepts the offering, the user inputs and transmits, via a user device, transaction information including the identifier to the remote location; and
receiving confirmation information on whether the transaction was facilitated by the remote location.

18. The method of claim 17, wherein the transaction further comprises payment for goods and/or services.

19. The method of claim 17, wherein the transaction information further comprises a symbol associated with the transaction, and wherein the confirmation information further comprises the symbol.

20. The method of claim 17, wherein the receiving confirmation information further comprises receiving notification on corresponding employee user devices.

21. The method of claim 17, wherein the receiving confirmation information further comprises receiving the confirmation information on a computer device located in the POS location, wherein the confirmation information is displayed on the computer device.

22. The method of claim 21, wherein the computer device displays a custom application that displays payments on the computer device.

23. The method of claim 22, wherein the custom application further comprises a Java application wherein movement of the payments is displayed in connection with the POS location.

24. The method of claim 17, wherein the transaction information further comprises one or more additional unique identifiers.

25. The method of claim 17, wherein the offering further comprises offering the identifier verbally and/or placing a sticker comprising the identifier as part of or on a display, a tray, a check, a bill, a table, or on self-operated machines thereon.

26. The method of claim 17, wherein the offering further comprises placing the identifier on at least one item or product linked to inventory of a seller, wherein the inventory is updated upon receiving confirmation information that the transaction was facilitated by the remote location.
